(19) United States
(12) Patent Application Publication
(10) Pub. No.: US 2022/0207614 A1
(43) Pub. Date: Jun. 30, 2022

(54) Grants Lifecycle Management System and Method

(71) Applicants: John Lee McCullough, JR., Lawrenceville, GA (US); Carl Willie Henson, III, Calhoun, GA (US)

(72) Inventors: John Lee McCullough, JR., Lawrenceville, GA (US); Carl Willie Henson, III, Calhoun, GA (US)

(73) Assignee: NAVOMI INC, Roswell, GA (US)

(21) Appl. No.: 17/137,999

(22) Filed: Dec. 30, 2020

(51) Int. Cl. G06Q 40/06; G06F 16/31; G06F 16/335; G06F 16/35; G06F 16/338; G06N 5/02

(52) U.S. Cl. CPC G06Q 40/06; G06F 16/313; G06N 5/022; G06F 16/35; G06F 16/338; G06F 16/335

(57) ABSTRACT

This disclosure relates generally to grants lifecycle management system and method. The method includes extracting a set of grant records from a content management platform based on a grant request submission, validating the extracted one or more primary grant attributes based on the grant request submission and a corresponding grant request reception, merging the validated one or more primary grant attributes with one or more secondary grant attributes to obtain enhanced grant attributes, constructing a first data set using the enhanced grant attributes, optimizing the first data set data using the second data set and generating a dynamic prediction engine for the grant request submission, at each phase of a grants lifecycle management.

### TECHNICAL FIELD

The disclosure herein generally relates to grants lifecycle, and, more particularly, to grants lifecycle management system and method.

### BACKGROUND

For grant-seekers, grants management is essential for maintenance of cordial relationships with funders. Similarly, for the grant-makers, efficacious grants management helps ensure that their valuable money is spent in fulfilling the vision and mission of their organization. With a competent grants management system in place, process of application, submission, tracking, and awarding of the grants can be wholly simplified and better organized. Grant-making systems for medical affairs and researches have been typically developed spontaneously and tedious. Such systems are often discrepant and complicated. The process of grant application involves lengthy paperwork, submissions, meetings, deadlines, and much more. Hence, prioritizing grants management is more essential than ever.

### SUMMARY OF INVENTION

Embodiments of the present disclosure present technological improvements as solutions to one or more of the above-mentioned technical problems recognized by the inventors in conventional systems. For example, in one embodiment, a processor implemented method for grants lifecycle management is provided. The method includes extracting a set of grant records from a content management platform based on a grant request submission, the set of grant records includes one or more primary attributes associated with each of a grant record from the set of grant records. The method further includes validating the extracted one or more primary grant attributes based on the grant request submission and a corresponding grant request reception. The method further includes merging the validated one or more primary grant attributes with one or more secondary grant attributes to obtain enhanced grant attributes, the one or more secondary grant attributes extracted from one or more secondary sources. The method further includes constructing a first data set using the enhanced grant attributes, wherein constructing the first data set comprises iteratively performing filtration on a set of the enhanced grant attributes and selectively grouping non-filtration set of the enhanced grant attributes as second data set. The method further includes optimizing the first data set data using the second data set. The method further includes generating a dynamic prediction engine for the grant request submission, at each phase of a grants lifecycle management, based on the optimized first data set.

In another embodiment, a system for grants lifecycle management is provided. The system includes a memory storing instructions, and one or more hardware processors coupled to the memory via the one or more communication interfaces. The one or more hardware processors are configured by the instructions to extract a set of grant records from a content management platform based on a grant request submission, the set of grant records includes one or more primary attributes associated with each of a grant record from the set of grant records. The system is further configured to validate the extracted one or more primary grant attributes based on the grant request submission and a corresponding grant request reception. The system is further configured to merge the validated one or more primary grant attributes with one or more secondary grant attributes to obtain enhanced grant attributes, the one or more secondary grant attributes extracted from one or more secondary sources. The system is further configured to construct a first data set using the enhanced grant attributes, wherein constructing the first data set includes iteratively performing filtration on a set of the enhanced grant attributes and selectively grouping non-filtration set of the enhanced grant attributes as second data set. The system is further configured to optimize the first data set data using the second data set. The system is further configured to generate a dynamic prediction engine for the grant request submission, at each phase of a grants lifecycle management, based on the optimized first data set.

In yet another embodiment, one or more non-transitory machine readable information storage mediums are provided. Said one or more non-transitory machine readable information storage mediums comprises one or more instructions which when executed by one or more hardware processors causes extracting a set of grant records from a content management platform based on a grant request submission, the set of grant records includes one or more primary attributes associated with each of a grant record from the set of grant records. The method further includes validating the extracted one or more primary grant attributes based on the grant request submission and a corresponding grant request reception. The method further includes merging the validated one or more primary grant attributes with one or more secondary grant attributes to obtain enhanced grant attributes, the one or more secondary grant attributes extracted from one or more secondary sources. The method further includes constructing a first data set using the enhanced grant attributes, wherein constructing the first data set includes iteratively performing filtration on a set of the enhanced grant attributes and selectively grouping non-filtration set of the enhanced grant attributes as second data set. The method further includes optimizing the first data set data using the second data set. The method further includes generating a dynamic prediction engine for the grant request submission, at each phase of a grants lifecycle management, based on the optimized first data set.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary block diagram of a system for grants management process lifecycle according to an embodiment of the present disclosure.

FIG. 2 depicts a exemplary block diagram illustrating a functional flow for grants learning pipeline using the system of FIG. 1 in accordance with some embodiments of the present disclosure.

FIG. 3 depicts a exemplary block diagram illustrating a functional flow for generating a dynamic prediction engine using the system of FIG. 1 in accordance with some embodiments of the present disclosure.

FIG. 4 is a flow diagram illustrating a method for grants management process lifecycle in accordance with some embodiments of the present disclosure.

FIG. 5 illustrates a block diagram of a system for grants management process lifecycle in accordance with some embodiments of the present disclosure.

### DETAILED DESCRIPTION OF EMBODIMENTS

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the claims (when included in the specification).

Typically, effective and efficient grants management involves challenging, disorganized, and complex set of processes. More specifically, in life sciences and healthcare industry the need for effective grants management process is rising exponentially where the private sector contributes the largest chunk of research & development money. This calls for digitalization and modernization of the grant management process for the life sciences and healthcare industry to make it simpler and hassle-free. Implementing a grant management system can significantly enhance an organization's efficiency, accountability, and compliance.

Various embodiments of the present disclosure provides systems and methods for grants lifecycle management systems and methods. In other words, the present disclosure proposes a for prediction engine for the success of a grant submission based on one or more attributes associated with the grant submission and the grant receptor.

Embodiments of the present disclosure describes a grants lifecycle management system and method. The present disclosure describes a configurable, cloud-based, software-as-a-service (SaaS) application with access to repository and documentation from a content management platform to modernize the grants management processes for various technical domains. The present disclosure provides a comprehensive grant management dynamic recommendations engine while the grant application is still under the creation/submission stage. This feature is a hybrid of dynamic prediction engine based on collaborative and content-based filtering. In an example, the grant management processes describes method for life sciences and healthcare domains

In an embodiment, the content management platform may be a cloud application development platform for customizing, integrating, and extending applications. In an example embodiment, the content management platform may be Veeva® Vault Platform. The platform enables usability, scalability, performance, validation, and security requirements and modify existing applications or configure new cloud applications based on a specific need of an organization or domain specific nature of the organization, for example, a life sciences domain application. The platform also facilitates content and data in a single platform enabling a user to deploy applications that manage end-to-end processes with related content, data, and workflows.

The present disclosure also provides AI (Artificial Intelligence)-powered virtual assistant that adeptly provides resolutions to numerous frequently asked questions, and/or queries related to documentation of the grant management procedure. The present disclosure also provides an intuitive user-interface for both web and mobile, built using proven technology stack and platforms that offer rich user experience and scalability. The user-interface is integrated with the platform's workflow engines to enable configuration according to internal standard operating procedures (SOP) of an organization. The present disclosure also includes prebuilt templates of approval processes for a given industry. The present disclosure incorporates intelligent tracking/analytics system to synchronously control and manage different grants for a given organizations, which includes but not limited to standard security for enterprises with user authentication, privacy, and regular audit monitoring. The present disclosure includes a centralized grants data with a single point of data storage for all the sourced grants data from primary and secondary sources. The present disclosure provides a system which is accessible anywhere via any device where core grant business operations are streamlined and standardized by employing a collection of configurable modules and an intuitive grant management user-interface.

The present disclosure enables exchange of communication between the front end connect as well as provides real-time status for each of the grant submission at each stage of the lifecycle. The present disclosure also facilitates a web portal that generates real time status update on each of the grant submission. The web portal is agile and may be used to connect with the back hand content, integrated with various systems, for example repository and documentations containing grant records and associated information of grant records. This presents disclosure presents a full-featured grant management system built on a true cloud enterprise content management platform, leveraging a single page web application, an ubiquitous web service platform and an advanced development suite for conversational AI applications and computing services.

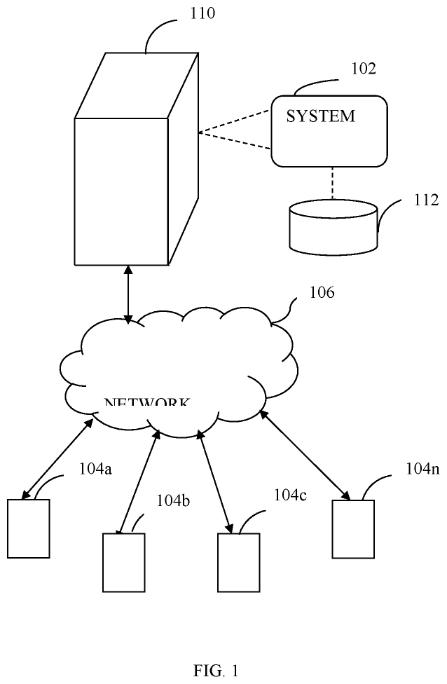

A detailed description of the above described system and method for grants management process lifecycle is shown with respect to illustrations represented with reference to FIGS. 1 through 5.

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Referring now to the drawings, and more particularly to FIG. 1 through 4, where similar reference characters denote corresponding features consistently throughout the figures, there are shown preferred embodiments and these embodiments are described in the context of the following exemplary system and/or method.

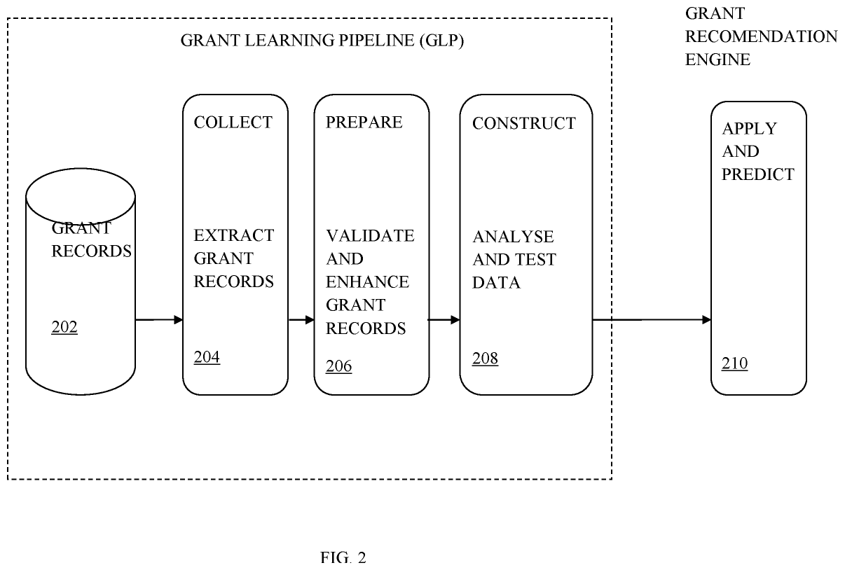

FIG. 1 illustrates a network environment 100 implementing a system 102 for grants management process lifecycle, according to an embodiment of the present subject matter. In one example embodiment, the system 102 is capable of grants lifecycle management, in particular, developing a first data set based on a particular grant submission request and one or more grant request reception. In an example embodiment, the grants lifecycle management includes but not limited to submission, review, approve, pending and close. The lifecycle may include further sub-stages namely, pre-screening of the grant submission, determining eligibility criteria of the submission, approval of the review committee of legal, compliance, contract, medical etc. The pending stage may further include pending for more information, signed documentation, pending contact et. al. The present disclosure enables collecting grant records, preparing the collected set of grant records and constructing a first data set using enhanced grant attributes. The enhanced grant attributes are obtained by normalizing and validating the one or more primary grant attributed extracted from the grant records. The first data set is analyzed and tested using second data set to obtained an optimized first data set. The optimized data set is used for building prediction engine as shown in FIG. 2.

Herein, the system 102 may capture an grant request submission, for example, submission via multiple devices and/or machines 104a, 104b, 104c . . . 104n, collectively referred to as devices 104 hereinafter. Examples of the devices 104 may include, but are not limited to, a portable computer, a personal digital assistant, a handheld device, VR camera embodying devices, storage devices equipped to capture and store the images/videos, and so on. In an embodiment, the devices 104 may include devices capable of obtaining information from one or more sources and receiving an grant request submission containing profile characteristics and historical characteristic data corresponding to the grant request submission and grant request reception. The devices 104 are communicatively coupled to the system 102 through a network 106, and may be capable of transmitting the obtained information from one or more sources to the system 102.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

The devices 104 may send the information associated grant request submission to the system 102 via the network 106. The system 102 is caused to generate a dynamic prediction engine, based on the developed first data set and second data set, for each stage of the grant management process lifecycle. In an embodiment, the system 102 may be embodied in a computing device 110. Examples of the computing device 110 may include, but are not limited to, a desktop personal computer (PC), a notebook, a laptop, a portable computer, a smart phone, a tablet, and the like. The system 102 may also be associated with a data repository 112 to store the media stream and/or images. Additionally or alternatively, the data repository 112 may be configured to store data from one or more sources and/or information generated during grants lifecycle management. The repository 112 may be configured outside and communicably coupled to the computing device 110 embodying the system 102. Alternatively, the data repository 112 may be configured within the system 102.

In an embodiment, the system 102 includes a content management platform containing various grant records and one or more primary grant attributes associated with each of the grant records. The disclosed system 102 enables constructing a first data set using enhanced grant attributes. The first data set is constructed by iteratively performing filtration on a set of the enhanced grant attributes and grouping non-filtration set of the enhanced grant attributes as second data set and optimized applying the second data set. The system also enables generating a dynamic prediction engine for the grant request submission, at each phase of the grants lifecycle management, based on the optimized first data set.

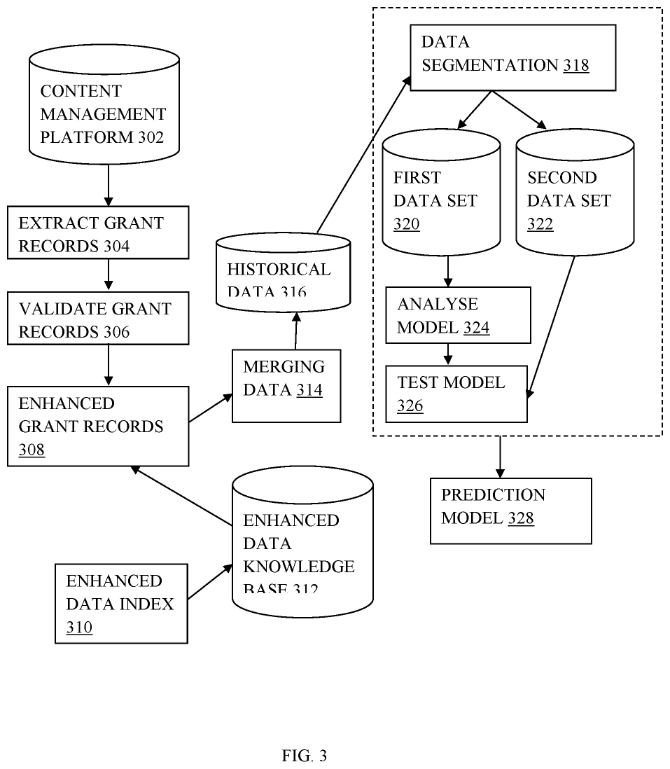

An example representation of the construction of first data set using enhanced grant attributes and generating a dynamic prediction engine using the optimized set of first data set and second data set using the system 102 is shown and described further with reference to FIG. 3

Referring to FIG. 2, grant records from a repository 202, for example a repository like a content management platform is stored. The method of collecting, preparing and constructing grant records is collectively referred as grant learning pipeline (GPL). The grant records are extracted 204 based on a grant request submission. The grants records extraction corresponds to the information provided in a grant request submission and a grant request reception, including profile and historic characteristics of the submission and reception. For each grant records, one or more primary attributes associated with the grant request submission is extracted. The extracted grant records are prepared 206 by validating and enhancing the extracted grant records. The extracted grant records are validated using enhanced data index and enhanced knowledge base as shown in FIG. 3. The enhanced grant attributes is used for constructing 208 an analyses model and a test model as shown in FIG. 3. The process steps of grant learning pipeline is then used in a dynamic prediction engine 210 for determining the success rate of obtaining grant for the grant request submission. In an embodiment, the grant request submission is obtained from a user accessing the workflow by using a registered user name and password for a particular grant request acceptor (grant awarder). There may be a one or more grant request submission (one or more accounts) for a particular grant request acceptor. Herein, the grant request acceptor may be specific to a domain, a particular area of interest or a standard organization.

As is seen from FIG. 2, upon processing by the system 102, the grant request submission by a registered user is accepted into the workflow and at the start of the creation/submission phase of the request submission, the registered user may access the success rate of obtaining a grant with the help of the dynamic prediction engine build using the present disclosure. The present disclosure allows a grant submitter to upload supporting documentation in the form of Adobe® Portable Document Format (PDF), Microsoft® Word document, or any other suitable files. The present disclosure also provides the grant submitter with the ability to view the status of the grant request, to be notified of changes to the grant request status, download contracts required for the grant process, complete any pending tasks, for example furnish information required by the grant makers and upload additional information requested by the grant makers (grant request reception). Herein, it will be noted that the embodiments have been explained by considering for an example embodiments.

In an embodiment, the system 102 may be caused to generate the dynamic prediction engine for determining a success rate of obtaining a grant. An example flow-diagram illustrating method for generating a prediction engine on a content management platform is described in detail with reference to FIG. 3. Although the present subject matter is explained considering that the system 102 is implemented for generating a prediction engine using analysis and test model, it may be understood that the system 102 may not be restricted to any particular machine or environment. The system 102 can be utilized for a variety of domains where grants lifecycle management is involved. The system 102 may be implemented in a variety of computing systems, such as a laptop computer, a desktop computer, a notebook, a workstation, a mainframe computer, a server, a network server and the like.

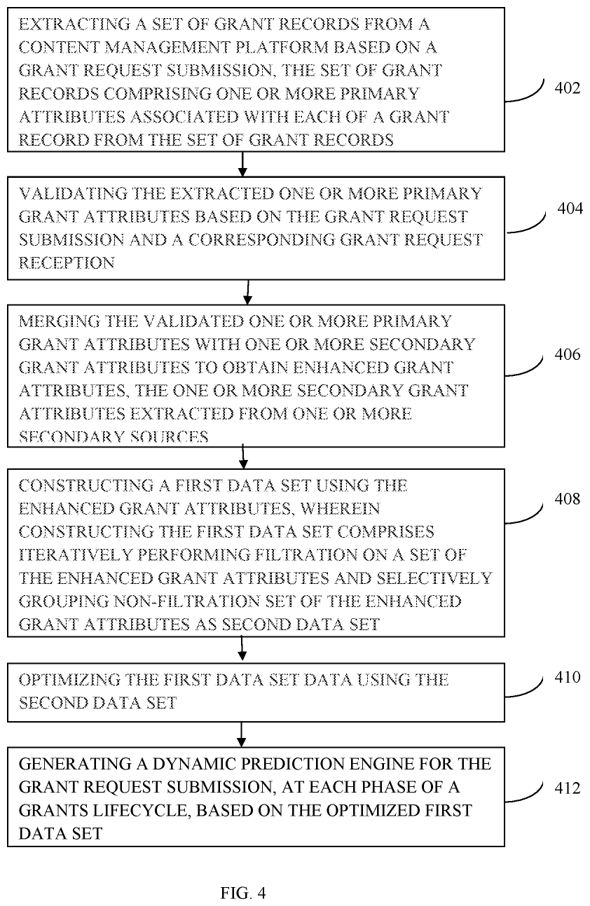

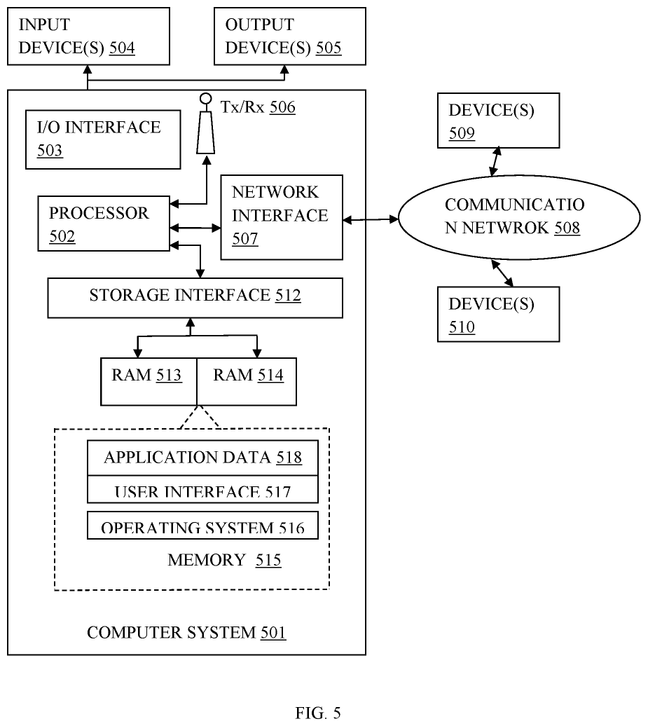

Referring now to FIG. 4, a flow-diagram of a method 400 for grants management process lifecycle is described, according to some embodiments of present disclosure. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communication network. The order in which the method 400 is described is not intended to be construed as a limitation, and any number of the described method blocks can be combined in any order to implement the method 400, or an alternative method. Furthermore, the method 400 can be implemented in any suitable hardware, software, firmware, or combination thereof. In an embodiment, the method 400 depicted in the flow chart may be executed by a system, for example, the system 102 of FIG. 1. In an example embodiment, the system 102 may be embodied in an exemplary computer system, for example computer system 501 (FIG. 5). The method 400 of FIG. 4 will be explained in more detail below with reference to FIGS. 1-3.

Referring to FIG. 4, in the illustrated embodiment, the method 400 is initiated at 402 where the method includes extracting a set of grant records from a content management platform based on a grant request submission. The set of grant records includes one or more primary attributes associated with each of a grant record from the set of grant records. The set of grant records are extracted based on the profile characteristics of grant request submission. Herein, the profile characteristics, for example in life sciences and healthcare domain, of grant request submission may include but are not limited topic of interest, therapeutic area, program summary (how the funds be used), intended objectives of usage of grant, location of the submitter, start and end dates of the project the grant is requested for, amount requested, total budget, request date—event date, audience (number of attendees & demographics), submitter's profile and organization profile. For example, the content management platform may be a cloud application development platform for customizing, integrating, and extending applications. In an example embodiment, the content management platform may be Veeva® Vault Platform. The platform enables usability, scalability, performance, validation, and security requirements and modify existing applications or configure new cloud applications. The platform also facilitates content and data in a single platform enabling a user to deploy applications that manage end-to-end processes with related content, data, and workflows.

In an embodiment, a grant submission may be uploaded (posted) in the form of a Adobe® Portable Document Format (PDF), Microsoft® Word document or any other suitable files to a web portal built on a, for example, content management platform. For the posted grant submission the set of grant records from a content management platform is extracted based on a grant request submission. The set of grant records includes one or more primary attributes associated with each of a grant record from the set of grant records. After the submission, a grant requestor may be able to view the status of the grant submission, and be notified of changes to the grant submission status, download contracts, complete assigned tasks, and upload additional information requested by a grant receptor. In an example embodiment, there may be one or more grant submission for a particular grant receptor (grantor).

At 404, the method includes validating the extracted one or more primary grant attributes. The method of validating includes classifying and de-duplicating the extracted one or more primary grant attributes. The classification and de-duplication of the extracted one or more primary grant attributes includes one or more data normalization process like classifying, tagging and removal of duplicate attributes. The validated one or more primary grant attributes is enhanced by merging with one or more secondary grant attributes to. The one or more secondary grant attributes extracted from one or more secondary sources. The method of validating and enhancing the grant attributes is shown in detail in FIG. 3.

At 406, the method includes merging the validated one or more primary grant attributes with one or more secondary grant attributes to obtain enhanced grant attributes. As shown in FIG. 3, the grant records (and associated one or more primary grant attributes) are extracted 304 from a repository, for example a content management platform 302. The one or more primary grant attributes corresponding to the grant request submission is enhanced 308 by using enhanced data indexer 310 and enhanced data knowledge base 312. The method of enhancing the one or more primary grant attributes includes utilization of an Enhanced Data Weighting Service (EDWS) that augments the data extracted from the grant request submission. The EDWS includes (a) a domain-specific data indexing process of structured and unstructured data from various sources, (b) organizing the indexed data into a comprehensive grants knowledge base and (c) REST (Representational State Transfer) based interface to facilitate communication thereafter. Herein, the domain-specific data indexing process sources data from secondary sources, namely, publicly accessible social media sites, posts from high authority (industry) blogs, company websites, and general search engine data. The sourced data from the includes structured and unstructured data and used as data points for further processing. For example, indexing may include adding weights to the data points. The structured and unstructured data is organized into a knowledge base containing data categorized by grant objective, grant specific company/organization, in the area of life sciences the drug/product/disease stage, submitter's company/organization, participants, event type, audience, facilitate/resource and the like. The aforementioned various sourced data is collectively referred as one or more secondary grant attributes. Further, the organized data from the enhanced data knowledge base 312 is merged 314 to obtain enhanced grant attributes. The merged data is continuously updated with the one or more secondary sources, stored as historical data 316. The merged data 314 is then updated with any of the newly sourced information to improve the accuracy of award score (predictability). Apart from the newly sourced information, the historical data also includes approved or denied data from the extracted grant records 304. The present method also factors in the sentiment analysis based on index searches, social media mentions, and blogs/articles/papers etc which facilitates in generating an updated first data set and second data set.

At 408, the method includes constructing a first data set using the enhanced grant attributes. The constructing of the first data set includes iteratively performing filtration on a set of the enhanced grant attributes and grouping non-filtration set of the enhanced grant attributes as second data set. As show in FIG. 3, the enhanced data 318 is segmented into the first data set and second data set. The first data set is constructed using analysis model 324 of analyzing a set of (that is a portion) the enhanced grant attributes by applying multiple filtration techniques. The iterative filtration comprises applying filtering technique based on characteristics associated with of grant request reception and the grant request submission. The filtration technique, in accordance with an example embodiment implements a combination of collaborative and content-based filtering approaches. The collaborative filtering is based on prior known characteristics or historical characteristics of a grant receptor (also referred herein as grant awarder), for example, previous grants awarded by said grant receptor. The content-based filtering methods are based on discrete characteristics of the grant (domain-specific) and profile characteristics of the grant submitter. This technique is used to determine favorable characteristics as profile characteristics via a learned classifier. The combination of said collaborative and content-based yields a more comprehensive footprint for comparison evaluation in generating a test model 326. The combinational filtration techniques also provides a comprehensive and near accurate prediction engine.

At 410, the method includes optimizing the first data set data by applying the second data set. The first data set includes the filtered set of enhanced grant attributes and the second data set includes a group of non-filtered enhanced grant attributes. Referring to FIG. 3, the analyze model 324 and test model 326 and applying the second data set 322 generates the optimized first data set. The non-filtration set from the enhanced grant attributes, that is the second data set facilities testing the accuracy of the first data set by selectively grouping the non-filtered enhanced grant attributes. The non-filtered enhanced grant attributes is selectively grouped, using strength of each of the enhanced grant attributes and relevancy of each of the enhanced grant attributes to the grant submission and grant request reception. For instance, in a life science example, some of the attributes with strong and relevant data points include but not limited to the topic of interest, therapeutic area, amount requested and clinical phase. These data points may also include product, program summary (how grants will be used), event type (objectives), location, start and end dates, total budget, request date, event date, audience (number of attendees & demographics), submitter, organization and the like. The selective grouping of the second set of data in combination with the profile and historic characteristic of the grant submission yields a near accurate success and non-success rate prediction.

At 412, the method includes generating a dynamic prediction engine for the grant request submission, at each phase of a grants lifecycle management, based on the optimized first data set. The dynamic prediction engine uses the optimized first data set and generates an automated computation to predicate an award score that near accurately indicates the award ability, that is success and non-success of a grant request submission. The award score may be utilized by both the grant submitter and the grant awarders. The predictive engine is also adapted to other domain specific requests. The present disclosure also provides a system implementing user interfaces, integration with document management systems for storing grants assets, enhanced workflows to provide accurate status tracking, alert notifications, real-time dashboards, AI powered virtual assistance and comprehensive reporting on each of the grant submissions. The report of each phase, that is sending notification to the grant submitter includes status, progress and success of the submission.

FIG. 5 is a block diagram of an exemplary computer system 501 for implementing embodiments consistent with the present disclosure. The computer system 501 may be implemented in alone or in combination of components of the system 102 (FIG. 1). Variations of computer system 501 may be used for implementing the devices included in this disclosure. Computer system 501 may comprise a central processing unit (“CPU” or “hardware processor”) 502. The hardware processor 502 may comprise at least one data processor for executing program components for executing user- or system-generated requests. The processor may include specialized processing units such as integrated system (bus) controllers, memory management control units, floating point units, graphics processing units, digital signal processing units, etc. The processor may include a microprocessor, such as AMD Athlon™ Duron™ or Opteron™, ARM's application, embedded or secure processors, IBM PowerPC™ Intel's Core, Itanium™, Xeon™, Celeron™ or other line of processors, etc. The processor 502 may be implemented using mainframe, distributed processor, multi-core, parallel, grid, or other architectures. Some embodiments may utilize embedded technologies like application specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.11 a/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc.

Output device(s) 505 may be a printer, fax machine, video display (e.g., cathode ray tube (CRT), liquid crystal display (LCD), light-emitting diode (LED), plasma, or the like), audio speaker, etc. In some embodiments, a transceiver (Tx/Rx) 506 may be disposed in connection with the processor 502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 502.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 502.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 509 and 510. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 801 may itself embody one or more of these devices.

In some embodiments, the processor 502 may be disposed in communication with one or more memory devices (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc. Variations of memory devices may be used for implementing, for example, any databases utilized in this disclosure.

The memory devices may store a collection of program or database components, including, without limitation, an operating system 516, user interface 517, user/application data 518 (e.g., any data variables or data records discussed in this disclosure), etc. The operating system 516 may facilitate resource management and operation of the computer system 501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, computer system 501 may store user/application data 518, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

Additionally, in some embodiments, the server, messaging and instructions transmitted or received may emanate from hardware, including operating system, and program code (i.e., application code) residing in a cloud implementation. Further, it should be noted that one or more of the systems and methods provided herein may be suitable for cloud-based implementation. For example, in some embodiments, some or all of the data used in the disclosed methods may be sourced from or stored on any cloud computing platform.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims (when included in the specification), the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments.

What is claimed is:

1. A processor-implemented method comprising:
extracting a set of grant records from a content management platform based on a grant request submission, the set of grant records comprising one or more primary attributes associated with each of a grant record from the set of grant records;
validating the extracted one or more primary grant attributes based on the grant request submission and a corresponding grant request reception;
merging the validated one or more primary grant attributes with one or more secondary grant attributes to obtain enhanced grant attributes, the one or more secondary grant attributes extracted from one or more secondary sources;
constructing a first data set using the enhanced grant attributes, wherein constructing the first data set comprises iteratively performing filtration on a set of the enhanced grant attributes and selectively grouping non-filtration set of the enhanced grant attributes as second data set;
optimizing the first data set data using the second data set; and
generating a dynamic prediction engine for the grant request submission, at each phase of grants lifecycle, based on the optimized first data set.

2. The method of claim 1, the method further comprising sending status notification at each phase of the grants lifecycle management of the grant request submission.

3. The method of claim 1, wherein the one or more primary grant attributes and the one or more secondary grant attributes comprises features associated with lifecycle of the grant request submission.

4. The method of claim 1, wherein validating the extracted one or more primary grant attributes comprises classifying and de-duplicate the extracted one or more primary grant attributes.

5. The method of claim 1, wherein obtaining the enhanced grant attributes comprises:
indexing domain-specific unstructured data associated with the one or more primary attributes; and
organizing the unstructured data into a knowledge base categorized by profile characteristics of the grant request submission and the grant request reception.

6. The method of claim 1, wherein the iterative filtration comprises applying filtering on the enhanced grant attributes based on profile characteristics of the grant request submission.

7. The method of claim 1, wherein performing the iterative filtration is determined based on historical characteristics of the grant request reception and discrete characteristics of the grant the grant submission.

8. The method of claim 1, wherein optimizing the first date set comprises cross-validating filtered enhanced grant attributes in the first data set with non-filtered enhanced grant attributes in the second data set.

9. The method of claim 1, wherein the dynamic prediction engine comprises computing an award score for the grant request submission.

10. A system comprising:
a memory storing instructions;
a processor coupled to the memory, wherein the processor is configured by the instructions to:
extract a set of grant records from a content management platform based on a grant request submission, the set of grant records comprising one or more primary attributes associated with each of a grant record from the set of grant records;
validate the extracted one or more primary grant attributes based on the grant request submission and a corresponding grant request reception;
merge the validated one or more primary grant attributes with one or more secondary grant attributes to obtain enhanced grant attributes, the one or more secondary grant attributes extracted from one or more secondary sources;
construct a first data set using the enhanced grant attributes, wherein constructing the first data set comprises iteratively performing filtration on a set of the enhanced grant attributes and selectively grouping non-filtration set of the enhanced grant attributes as second data set;
optimize the first data set data using the second data set; and generate a dynamic prediction engine for the grant request submission, at each phase of a grants lifecycle, based on the optimized first data set.

11. The system of dam 10, further configured to send status notification at each phase of grants lifecycle management corresponding to the grant request submission.

12. The system of claim 10, wherein the one or more primary grant attributes and the one or more secondary grant attributes comprises features associated with lifecycle of the grant request submission.

13. The system of claim 10, wherein validating the extracted one or more primary grant attributes comprises classifying and de-duplicate the extracted one or more primary grant attributes.

14. The system of claim 10, wherein obtaining the enhanced grant attributes comprises:
indexing domain-specific unstructured data associated with the one or more primary attributes; and
organizing the unstructured data into a knowledge base categorized by profile characteristics of the grant request submission and the grant request reception.

15. The system of claim 10, wherein the iterative filtration comprises applying filtering on the enhanced grant attributes based on profile characteristics of the grant request submission.

16. The system of claim 10, wherein performing the iterative filtration is determined based on historical characteristics of the grant request reception and discrete characteristics of the grant the grant submission.

17. The system of claim 10, wherein optimizing the first date set comprises cross-validating filtered enhanced grant attributes in the first data set with non-filtered enhanced grant attributes in the second data set.

18. The system of claim 10, wherein the dynamic prediction engine comprises computing an award score for the grant request submission.

19. A non-transitory computer-readable medium having embodied thereon a computer program for executing a method gene prioritization, the method comprising:
extracting a set of grant records from a content management platform based on a grant request submission, the set of grant records comprising one or more primary attributes associated with each of a grant record from the set of grant records;
validating the extracted one or more primary grant attributes based on the grant request submission and a corresponding grant request reception;
merging the validated one or more primary grant attributes with one or more secondary grant attributes to obtain enhanced grant attributes, the one or more secondary grant attributes extracted from one or more secondary sources;
constructing a first data set using the enhanced grant attributes, wherein constructing the first data set comprises iteratively performing filtration on a set of the enhanced grant attributes and selectively grouping non-filtration set of the enhanced grant attributes as second data set; optimizing the first data set data using the second data set; and
generating a dynamic prediction engine for the grant request submission, at each phase of a grants lifecycle, based on the optimized first data set.

20. The non-transitory computer-readable medium having embodied thereon a computer program for executing a method gene prioritization, the method further comprising sending status notification at each phase of the grants management lifecycle of the grant request submission.
